(19) United States
(12) Patent Application Publication
(10) Pub. No.: US 2026/0370267 A1
(43) Pub. Date: Nov. 19, 2026

(54) WIRELESS COMMUNICATION SYSTEM, WIRELESS COMMUNICATION DEVICE, WIRELESS COMMUNICATION METHOD AND WIRELESS COMMUNICATION PROGRAM

(71) Applicant: NTT, Inc., Tokyo (JP)

(72) Inventors: Minoru INOMATA, Musashino-shi, Tokyo (JP); Wataru YAMADA, Musashino-shi, Tokyo (JP)

(73) Assignee: NTT, Inc., Tokyo (JP)

(21) Appl. No.: 19/143,953

(22) PCT Filed: Jan. 6, 2023
(86) PCT No.: PCT/JP2023/000231

§ 371 Date: Jun. 27, 2025

(51) Int. Cl. H04B 7/0413; H04B 17/20

(52) U.S. Cl. CPC H04B 7/0413; H04B 17/252

(57) ABSTRACT

A wireless communication system that estimates an arrival state of a radio wave for each arrival angle, and includes an array antenna part that receives the radio wave, an RF-IF front-end part, and a baseband unit that estimates the arrival state. The array antenna part includes a plurality of rectangular waveguides arranged in a cylindrical shape so that tube axes are parallel to each other, and a cylindrical radial waveguide arranged inside a cylinder formed by the plurality of rectangular waveguides and T-shaped connected to the plurality of rectangular waveguides. The rectangular waveguide has a slot array in an arrangement direction parallel to a central axis of the cylinder on a wall serving as a side surface of the cylinder, and the radial waveguide and the rectangular waveguide are configured to be hollow waveguides. The baseband unit includes a plurality of digital signal processors that perform parallel processing.

### TECHNICAL

The present invention relates to a wireless communication system, a wireless communication device, a wireless communication method, and a wireless communication program for estimating an arrival state of an arriving wireless radio wave for each arrival angle.

### BACKGROUND

The terahertz wave band assumed to be used in the 6G mobile communication system has a very short wavelength, and is greatly affected by a human body, a structure, and the like around a terminal such as a mobile phone. Therefore, it is necessary to precisely analyze an arrival state of wireless radio wave (hereinafter, referred to as radio wave) from the base station. In an analysis of an arrival state of millimeter wave (mmW) of 5G, a channel sounder using massive multi-input multi-output (MIMO) of several hundred elements is used to obtain a high antenna gain (See, for example, Non Patent Literature 1).

### CITATION LIST

### Non Patent Literature

Non Patent Literature 1: Minoru Inomata et al., “Radio Wave Visualizer for 5G New Radio signal”, The 2019 IEICE Communications Society Conference

### SUMMARY

### Technical Problem

However, in a microstrip line used in MassiveMIMO of the prior art, generally, a transmission loss tends to increase as a frequency increases. Therefore, there is a problem that the measurement distance range of the radio wave becomes very narrow in the channel sounder of the terahertz wave band.

In addition, in the terahertz wave band, since the performance of the front-end device is degraded more than the performance in mmW, there is a problem that high-precision calibration data cannot be obtained, and the arrival angle resolution in beamforming is degraded. Furthermore, in the terahertz wave band, since an ultra-wide band signal on the GHz order is used, a signal processing amount increases, and there is also a problem that a processing delay occurs in analysis of an arrival state in which real-time property is required.

In order to solve the above-described problems, an object of the present disclosure is to provide a wireless communication system capable of measuring a long-range arrival state with high angular resolution even in a radio wave in a terahertz wave band and realizing real-time signal processing.

In addition, an object of the present disclosure is to provide a wireless communication device capable of measuring a long-range arrival state with high angular resolution even in a radio wave in a terahertz wave band and realizing real-time signal processing.

In addition, an object of the present disclosure is to provide a wireless communication method capable of measuring a long-range arrival state with high angular resolution even in a radio wave in a terahertz wave band and realizing real-time signal processing.

In addition, an object of the present disclosure is to provide a wireless communication program capable of measuring a long-range arrival state with high angular resolution even in a radio wave in a terahertz wave band and realizing real-time signal processing.

### Solution to Problem

A first aspect of the present disclosure is a wireless communication system that estimates an arrival state of an arriving radio wave for each arrival angle, and it is preferable that the wireless communication system includes:
an array antenna part that receives the radio wave;
an RF-IF front-end part that converts a high-frequency reception signal generated by the array antenna part into a signal in an intermediate frequency band for each reception section of the array antenna part; and
a baseband unit that estimates the arrival state on a basis of the signal in the intermediate frequency band, in which
the array antenna part includes
a plurality of rectangular waveguides in which tube axes are parallel to each other and which are arranged in a cylindrical shape such that short sides are located on a circle in a rectangular cross section perpendicular to the tube axis, and
a cylindrical radial waveguide disposed inside a cylinder formed by the plurality of rectangular waveguides and T-shaped connected to the plurality of rectangular waveguides,
the radial waveguide includes
a plurality of feed openings arranged to have rotational symmetry about a central axis of the cylinder,
the rectangular waveguide includes
a slot array in an arrangement direction parallel to the central axis of the cylinder on a wall that is a side surface of the cylinder,
the radial waveguide and the rectangular waveguide are configured to be hollow waveguides, and
the baseband unit includes
a plurality of digital signal processors that perform parallel processing on the digitized signal in the intermediate frequency band.

A second aspect of the present disclosure is a wireless communication device that estimates an arrival state of a radio wave received by another wireless device for each of arrival angles, and it is preferable that the wireless communication device is configured to execute:
processing of receiving a signal in an intermediate frequency band based on a reception signal of a radio wave received by the other wireless device for each of reception sections of the other wireless device;
I/Q signal extraction processing of digitizing the signal in the intermediate frequency band for each of the reception sections to extract an in-phase component and a quadrature-phase component;
I/Q signal synthesis processing of collecting and synthesizing digital signals of the in-phase component and the quadrature-phase component extracted in the I/Q signal extraction processing for all the reception sections;
synchronization processing of performing a correlation calculation on a result of the I/Q signal synthesis processing and detecting a transmission timing of the reception signal at which a correlation value is maximized;
demodulation processing of performing OFDM demodulation on a result of the I/Q signal synthesis processing on a basis of the transmission timing;
channel estimation processing of calculating, for each subcarrier and each of the reception sections, a channel estimation value that is an estimation result of an amplitude and a phase when the radio wave passes through a propagation path on a basis of a result of the demodulation processing;
beamforming processing of calculating a delay profile of the radio wave for each of arrival angles on a basis of a result obtained by performing an IFFT processing on the channel estimation value;
processing of calculating a reception level for each of the arrival angles of the radio waves on a basis of the delay profile; and
arrival path extraction processing of extracting an arrival path for each of the arrival angles of the radio wave on a basis of a reception level for each of the arrival angles, and the wireless communication device includes
a plurality of digital signal processors that execute the I/Q signal synthesis processing in parallel.

A third aspect of the present disclosure is a wireless communication method for estimating an arrival state of an arriving radio wave for each of arrival angles, and it is preferable that the wireless communication method includes:
receiving the radio wave by an array antenna part;
converting a high-frequency reception signal generated by the array antenna part into a signal in an intermediate frequency band for each of reception sections of the array antenna part by an RF-IF front-end part;
digitizing, by a baseband unit, the signal in the intermediate frequency band for each of the reception sections to extract an in-phase component and a quadrature-phase component;
collecting and synthesizing, by a baseband unit, digital signals of the in-phase component and the quadrature-phase component for all of the reception sections;
performing, by a baseband unit, a correlation calculation on a result of the synthesizing and detecting a transmission timing of the reception signal at which a correlation value is maximized;
performing, by a baseband unit, OFDM demodulation on a result of the synthesizing on a basis of the transmission timing;
calculating, by a baseband unit, for each subcarrier and each of the reception sections, a channel estimation value that is an estimation result of an amplitude and a phase when the radio wave passes through a propagation path on a basis of a result of the OFDM demodulation;
calculating, by a baseband unit, a delay profile of the radio wave for each of the arrival angles on a basis of a result obtained by performing IFFT processing on the channel estimation value;
calculating, by a baseband unit, a reception level for each of the arrival angles of the radio wave on a basis of the delay profile; and
extracting, by a baseband unit, an arrival path for each of the arrival angles of the radio wave on a basis of a reception level for each of the arrival angles.

A fourth aspect of the present disclosure is a wireless communication program executed by a wireless communication device that estimates an arrival state of a radio wave received by another wireless device for each of arrival angles, and it is preferable that the wireless communication program includes a program for causing the wireless communication device to execute:
I/Q signal synthesis processing of collecting and synthesizing digital signals of an in-phase component and a quadrature-phase component extracted from a signal in an intermediate frequency band based on a reception signal of a radio wave received by the other wireless device for all the reception sections of the other wireless device;
synchronization processing of performing a correlation calculation on a result of the I/Q signal synthesis processing and detecting a transmission timing of the reception signal at which a correlation value is maximized;
demodulation processing of performing OFDM demodulation on a result of the I/Q signal synthesis processing on a basis of the transmission timing;
channel estimation processing of calculating, for each subcarrier and each of the reception sections, a channel estimation value that is an estimation result of an amplitude and a phase when the radio wave passes through a propagation path on a basis of a result of the demodulation processing;
beamforming processing of calculating a delay profile of the radio wave for each of the arrival angles on a basis of a result obtained by performing IFFT processing on the channel estimation value;
processing of calculating a reception level for each of the arrival angles of the radio wave on a basis of the delay profile; and
arrival path extraction processing of extracting an arrival path for each of the arrival angles of the radio wave on a basis of the reception level for each of the arrival angles.

### Advantageous Effects of Invention

According to the first to fourth aspects of the present disclosure, it is possible to provide a wireless communication system, a wireless communication device, a wireless communication method, and a wireless communication program capable of measuring a long-range arrival state with high angular resolution even in a radio wave in a terahertz wave band and realizing real-time signal processing.

### BRIEF DESCRIPTION OF DRAWINGS

FIG. 1 is a diagram illustrating an example of a functional configuration of a wireless communication system according to a first embodiment of the present disclosure.

FIG. 2 is a block diagram illustrating a configuration example of the wireless communication system according to the first embodiment of the present disclosure.

FIG. 3 is an overall view of an array antenna according to the first embodiment of the present disclosure.

FIG. 4 is a cross-sectional view of the array antenna according to the first embodiment of the present disclosure taken along a diametrical direction.

FIG. 5 is a view of the array antenna according to the first embodiment of the present disclosure as viewed from the z-axis direction.

FIG. 6 is a configuration example of a slot array according to the first embodiment of the present disclosure.

FIG. 7 is a two-dimensional cross-sectional view obtained by cutting the array antenna according to the first embodiment of the present disclosure in a diametrical direction.

FIG. 8 is a diagram illustrating a configuration example of an RF-IF front-end part of the wireless communication system according to the first embodiment of the present disclosure.

FIG. 9 is a diagram illustrating a configuration example of a signal format used in the wireless communication system according to the first embodiment of the present disclosure.

FIG. 10 is a flowchart of processing performed by a baseband unit in the wireless communication system according to the first embodiment of the present disclosure.

### DESCRIPTION OF EMBODIMENTS

### First Embodiment

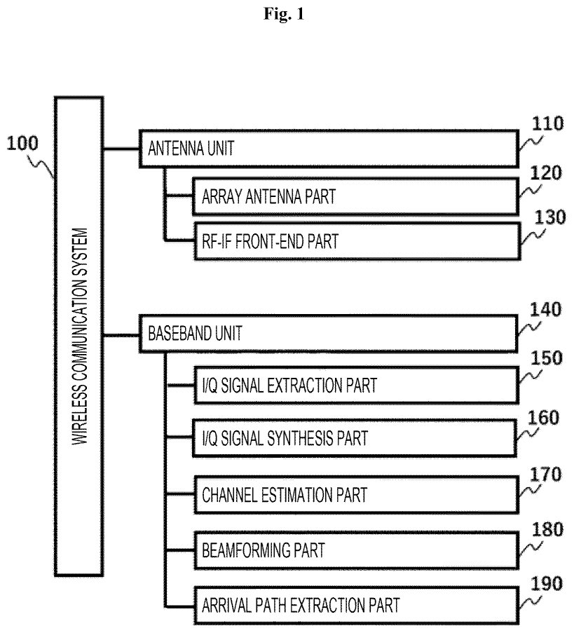

FIG. 1 is a diagram illustrating an example of a functional configuration of a wireless communication system according to a first embodiment of the present disclosure. An antenna unit 110 of a wireless communication system 100 includes an array antenna part 120 and an RF-IF front-end part 130. The array antenna part 120 is a part that receives arriving radio wave and generates a reception signal. The RF-IF front-end part 130 is a part that executes processing (hereinafter, referred to as RF front-end processing) of extracting and amplifying a desired signal of radio frequency (RF) generated in the array antenna part 120, and converting the signal into a signal in an intermediate frequency (IF) band. Further, it is a part that executes processing (hereinafter, referred to as IF front-end processing) of extracting a desired wave from the signal converted into the intermediate frequency band, amplifying and shaping the wave, and transmitting it to the baseband unit 140.

The baseband unit 140 includes an I/Q signal extraction part 150, an I/Q signal synthesis part 160, a channel estimation part 170, a beamforming part 180, and an arrival path extraction part 190. The I/Q signal extraction part 150 is a part that executes processing (hereinafter, referred to as I/Q signal extraction processing) of digitizing an analog signal and extracting an in-phase component and a quadrature-phase component.

The I/Q signal synthesis part 160 is a part that executes processing (hereinafter, referred to as I/Q signal synthesis processing) of collecting and synthesizing digital signals of the in-phase component and the quadrature-phase component input from the I/Q signal extraction part 150 for all the reception sections included in an array antenna 210.

The channel estimation part 170 is a part that executes processing (hereinafter, referred to as channel estimation processing) of calculating a channel estimation value, which is an estimation result of an amplitude, a phase, and the like when a radio wave passes through a propagation path, for each subcarrier and each of the reception sections.

The beamforming part 180 is a part that executes processing (hereinafter, referred to as beamforming processing) of calculating a delay profile for each of arrival angles with respect to the radio wave arriving at the array antenna part 120.

The arrival path extraction part 190 is a part that executes processing (hereinafter, referred to as arrival path extraction processing) of extracting an arrival path for each of arrival angles of the radio wave arriving at the array antenna part 120 on the basis of a reception level for each of arrival angles.

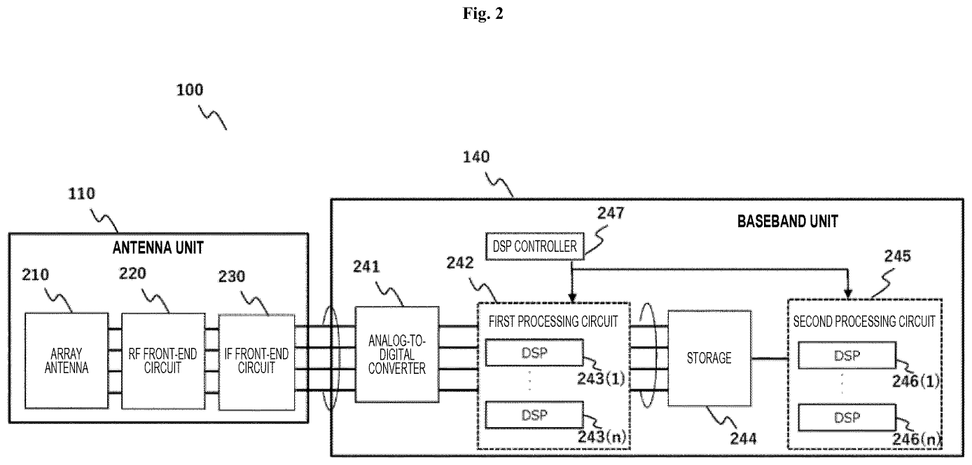

FIG. 2 is a block diagram illustrating a configuration example of the wireless communication system according to the first embodiment of the present disclosure. The array antenna 210 of the antenna unit 110 is the array antenna part 120 described above. The reception signal generated by the array antenna 210 is transmitted to the subsequent stage in units of sub-array antennas in which slot arrays included in the array antenna 210 are collected for each reception section.

That is, the reception signal in the array antenna 210 is transmitted to an RF front-end circuit 220 via Nₐₙₜ signal lines arranged for each of the Nₐₙₜ sub-array antennas. Note that Nₐₙₜ is the number of sub-array antennas included in the array antenna 210.

The RF front-end circuit 220 is a part that executes the RF front-end processing performed by the RF-IF front-end part 130 described above. The RF front-end circuit 220 performs signal processing for each sub-array antenna and transmits the processed signal to an IF front-end circuit 230 at the subsequent stage for each sub-array antenna.

The IF front-end circuit 230 is a part that executes the IF front-end processing performed by the RF-IF front-end part 130 described above.

After performing signal processing for each sub-array antenna, the IF front-end circuit 230 transmits a signal to a subsequent circuit for each group (hereinafter, referred to as a sub-array group) including a plurality of sub-array antennas.

That is, the signal from the IF front-end circuit 230 is transmitted to the subsequent baseband unit 140 via N_{g} signal lines arranged for each of the N_{g} sub-array groups. Here, N_{g} is the number of sub-array groups included in the array antenna 210. One signal line includes signals in (Nₐₙₜ/N_{g}) sub-array antennas.

An analog-to-digital converter 241 of the baseband unit 140 is a part that executes the above-described I/Q signal extraction processing. The I/Q signal extraction processing is performed in units of sub-array groups. In addition, the processed signal is transmitted to a first processing circuit 242 for each sub-array group via N_{g} signal lines.

Here, a coaxial cable or an optical fiber is used as a signal line connecting the analog to digital converter 241 and the first processing circuit 242. Note that, in each component of the baseband unit 140 described below, a coaxial cable or an optical fiber is used for signal transmission unless otherwise specified.

The first processing circuit 242 includes a plurality of digital signal processors (DSPs) 243(1), 243(2), . . . 243(n). The plurality of DSPs 243 are processors that implement the function of the I/Q signal synthesis part 160 described above.

That is, the baseband unit 140 includes the first processing circuit 242 for performing parallel processing of the I/Q signal synthesis processing performed by the I/Q signal synthesis part 160. By the I/Q signal synthesis processing performed by the first processing circuit 242, signals in (Nₐₙₜ/N_{g}) sub-array antennas included in one sub-array group are synthesized into one. As a result, signals (hereinafter, referred to as an intra-group synthesis signal) synthesized with the sub-array antennas included in the sub-array group can be obtained.

The function of the first processing circuit 242 is implemented by software, firmware, or a combination thereof. The software or firmware is described as a wireless communication program and stored in a storage 244. That is, the DSPs 243 implement the function by reading the wireless communication program stored in the storage 244 into the memory and executing the program. The memory corresponds to, for example, a volatile or nonvolatile semiconductor memory such as a RAM, a ROM, or a flash memory, or a magnetic disk, a flexible disk, an optical disk, a DVD, or the like.

The storage 244 is a storage device such as a hard disk drive or a solid state drive (SSD). The storage 244 is a part that further synthesizes the respective intra-group synthesized signals transmitted from the first processing circuit 242 via the N_{g} signal lines. As a result, signals (hereinafter, referred to as a total signal) synthesized for all the sub-array antennas can be acquired.

In this manner, the I/Q signal synthesis processing is executed by the first processing circuit 242 and the storage 244.

Here, it should be noted that since the total signal is a signal obtained by synthesizing the signals of all the sub-array groups, the number of signal lines connecting the storage 244 and a second processing circuit 245 is one. Note that a coaxial cable or an optical fiber is used as a signal line connecting the two. Alternatively, in a case where the second processing circuit 245 is a computer, an interface such as PCI Express (registered trademark) may be used.

The second processing circuit 245 includes a plurality of DSPs 246(1), 246(2), . . . 246(n) similarly to the first processing circuit 242. The plurality of DSPs 246 are processors that implement the functions of the channel estimation part 170, the beamforming part 180, and the arrival path extraction part 190 described above.

That is, the baseband unit 140 includes the second processing circuit 245 for performing parallel processing of the channel estimation processing performed by the channel estimation part 170, the beamforming processing performed by the beamforming part 180, and the arrival path extraction processing performed by the arrival path extraction part 190 on the total signal input from the storage 244. Similarly to the first processing circuit 242, the function of the second processing circuit 245 is implemented by software, firmware, or a combination thereof. The software or firmware is described as a wireless communication program and stored in a storage 244. Here, similarly to the first processing circuit 242, the DSPs 246 implement the function by reading the wireless communication program stored in the storage 244 into the memory and executing the program.

A DSP controller 247 is a part that integrally controls the first processing circuit 242 and the second processing circuit 245.

As described above, the wireless communication system 100 of the present disclosure implements the functions of the I/Q signal synthesis part 160, the channel estimation part 170, the beamforming part 180, and the arrival path extraction part 190 of the baseband unit 140 by using the first processing circuit 242 and the second processing circuit 245. A plurality of DSPs are arranged therein, and each DSP executes processing of each part in parallel. As a result, real-time signal processing can be realized without reducing the processing speed even in the signal processing of the terahertz wave band using the ultra-wide band signal of the GHz order.

### Modification

The second processing circuit 245 is a part that executes extraction of a reception level and a path from the delay profile for each arrival angle. Therefore, it can be said that the signal processing amount in the second processing circuit 245 is smaller than that in the first processing circuit 242 that handles the total signal. Therefore, in a case where real-time property is not required for analysis or the like, the second processing circuit 245 may be replaced with a computer including a CPU and a memory and storing a wireless communication program in the memory.

Note that the functions implemented by the second processing circuit 245 are not limited to the functions of the channel estimation part 170, the beamforming part 180, and the arrival path extraction part 190, and may include other processing.

In the above description, the total signal is generated in the storage 244, but the total signal may be generated by the first processing circuit 242.

Note that, in the above description, it has been described that the IF front-end circuit 230 performs signal processing for each sub-array antenna and then transmits a signal to a subsequent circuit for each sub-array group. However, signals for each sub-array antenna may be transmitted as they are to a subsequent circuit without being collected into the sub-array group. That is, N_{g}=Nₐₙₜ may be satisfied.

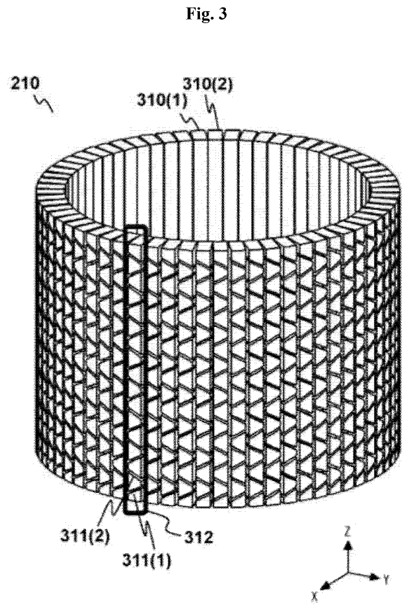

FIG. 3 is an overall view of the array antenna according to the first embodiment of the present disclosure. The array antenna 210 includes a plurality of rectangular waveguides 310(1), 310(2), . . . having a rectangular cross section in the xy plane and having a tube axis in the z-axis direction. The rectangular waveguide 310 is a hollow waveguide that transmits radio waves. The wall of the rectangular waveguide 310 is a conductor plate through which a current can flow. In the array antenna 210, the plurality of rectangular waveguides 310 are arranged in a cylindrical shape such that tube axes are parallel to each other and short sides are located on a circle in a rectangular cross section perpendicular to the tube axis. For example, in FIG. 3, 64 rectangular waveguides 310 are arranged in the circumferential direction.

Note that, in the present disclosure, in a case where description common to all of the rectangular waveguides 310(1), 310(2), . . . is given, they are referred to as rectangular waveguides 310 with (number) at the end of the reference sign omitted. Only when referring to a specific rectangular waveguide 310, (number) is added to the end of the reference sign to describe as a rectangular waveguide 310(1). In addition, a plurality of constituent elements appearing thereafter will be described in the same manner when there are a plurality of constituent elements.

Each of the rectangular waveguides 310 constituting a cylinder includes a plurality of slots 311(1), slots 311(2), . . . on a wall serving as a side surface of the cylinder. The slots 311 are periodically arranged in a direction parallel to the central axis of the cylinder. The slot 311 functions as a radiating element of an antenna that radiates a radio wave into space or guides a radio wave in space.

Hereinafter, a state in which the slots 311 are arranged in the arrangement direction parallel to the central axis of the cylinder formed by the rectangular waveguides 310 on the wall of the rectangular waveguide 310 is referred to as a slot array 312.

In addition, in the array antenna 210 of the present disclosure, the slot array 312 also has periodicity in the circumferential direction. By three-dimensionally arraying the slots 311 in this manner, it is possible to perform beamforming on radio waves arriving from the 360-degree direction, and the reception efficiency can be enhanced.

In addition, since cross polarization can be suppressed by loading the slits 351 in the array antenna 210, polarized waves in a single direction can be transmitted in the array antenna 210, and as a result, the identification efficiency of orthogonal polarization at the time of radio wave reception is enhanced.

As described above, the array antenna 210 of the present disclosure has a structure in which the slots 311, which are radiation elements, are regularly arranged in the direction parallel to the central axis of the cylinder and in the circumferential direction. As a result, the beamforming of the radio wave arriving from the 360-degree direction can be performed, and the antenna gain can be improved.

Note that the number of rectangular waveguides 310 illustrated in FIG. 3 is merely an example, and may be determined according to the use environment of the array antenna 210.

Further, it is desirable that the slots 311 are regularly arranged in a direction parallel to the central axis of the cylinder and in the circumferential direction, but the slots may not be necessarily periodic and may be unequally spaced.

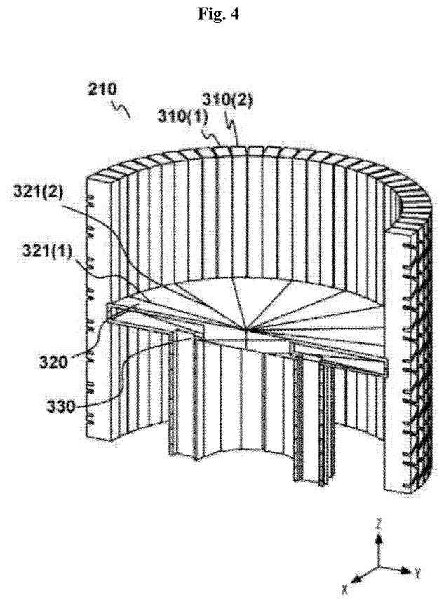

FIG. 4 is a cross-sectional view of the array antenna according to the first embodiment of the present disclosure taken along a diametrical direction. The array antenna 210 includes a cylindrical radial waveguide 320 disposed inside a cylinder formed by the rectangular waveguides 310. Like the rectangular waveguide 310, the radial waveguide 320 is also a hollow waveguide.

The radial waveguide 320 is a transmission line that radially transmits a radio wave. The radial waveguide 320 is connected to each of the rectangular waveguides 310 forming a cylinder, and guides the radio wave propagating in the rectangular waveguide 310 toward the center of the cylinder. Note that, in a cross section obtained by cutting the cylinder in the diametrical direction, the connection between the radial waveguide 320 and the rectangular waveguide 310 looks like a T-shape, and thus is hereinafter referred to as a T-shaped connection, a T-branch, or the like.

The feed opening 330 is an opening for supplying power. The plurality of feed openings 330 are arranged on the bottom surface of the cylindrical radial waveguide 320 so as to have rotational symmetry about the central axis of the cylinder formed by the rectangular waveguides 310. As a result, power can be uniformly transmitted in the circumferential direction.

In addition, the feed opening 330 is not only the above-described power transmission path but also the transmission path of the radio wave guided by each slot 311. The radio waves having passed through the feed openings 330 are collected in one place and converted into a power signal.

The plurality of walls 321 arranged in the radial direction from the center of the cylinder are walls that partition the feed openings 330, and are inserted to ensure electrical isolation between the feed openings 330.

As described above, the array antenna 210 includes the radial waveguides 320. As a result, a radio wave can be guided toward the center of the cylindrical structure formed by the rectangular waveguides 310 and transmitted to the feed opening 330.

As described above with reference to FIGS. 3 and 4, in the array antenna 210 of the present disclosure, a radio wave is transmitted in the hollow rectangular waveguide 310 and the hollow radial waveguide 320. On the other hand, in the antenna of the related art, a microstrip line is used, and a radio wave is transmitted on a dielectric substrate. As a result, a large transmission loss occurs in the terahertz wave band. In the present disclosure, the transmission loss of the radio wave in the terahertz wave band can be reduced by using the hollow waveguide.

Note that, in FIG. 4, the walls 321 are provided in the entire range in the radial direction of the radial waveguides 320, but are not necessarily provided in the entire range, as long as the electrical isolation of the feed openings 330 is realized. Also in this case, the same effects as those of the above-described radial waveguide 320 can be obtained.

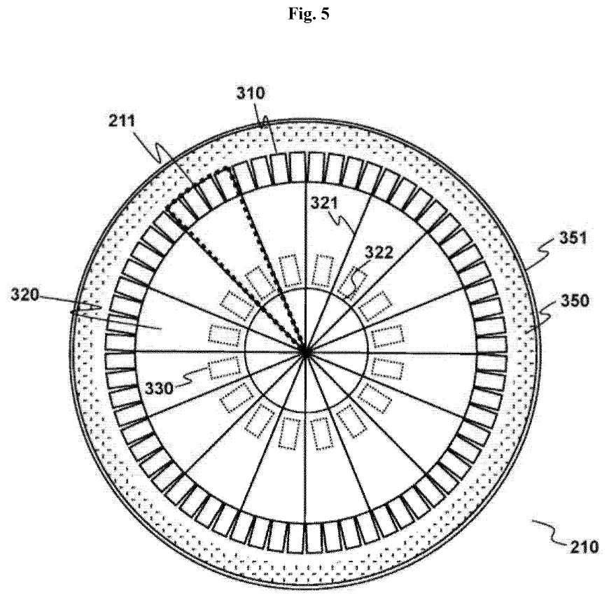

FIG. 5 is a view of the array antenna according to the first embodiment of the present disclosure as viewed from the z-axis direction. In FIG. 5, one radial waveguide 320, 16 feed openings, and 64 rectangular waveguides 310 are arranged.

The sub-array antenna 211 included in the array antenna 210 is obtained by collecting, as one unit, a reception section including the slot array 312 on the wall of the adjacent rectangular waveguides 310 in FIG. 5, one feed opening 330 included in the radial direction connecting the four rectangular waveguides 310 and the central axis of the cylinder, and the radial waveguide 320 connecting these. However, the number may not be limited thereto.

In addition, in the example of FIG. 5, since 64 rectangular waveguides 310 are arranged, the number of sub-array antennas Nₐₙₜ=(64/4)=16. In this case, the number of sub-array groups can be, for example, N_{g}=4.

The wall 322 provided on the circle inside the feed opening 330 is a wall for securing electrical isolation between the feed openings 330 facing each other.

A dielectric cylinder 350 is a cylindrical dielectric provided so as to surround the cylinder formed by the rectangular waveguides 310. A slit 351 for suppressing cross polarization is loaded on a side surface of the dielectric cylinder 350. The slit 351 is a slit cut in the circumferential direction of the dielectric cylinder 350, and has a structure periodically arranged in the z-axis direction.

As described above, by disposing the dielectric cylinder 350 on the outermost periphery of the array antenna 210, it is possible to suppress a polarized wave intersecting with a desired polarized wave among arriving radio waves, and it is possible to guide only the desired polarized wave into the rectangular waveguide 310.

As described above, in the array antenna 210, only a polarized wave in a single direction is propagated. In the radial waveguide 320, a polarized wave parallel to the bottom surface of the radial waveguide 320 is propagated.

Note that the numbers of the radial waveguides 320, the feed openings 330, and the rectangular waveguides 310 described in FIG. 5 are an example, and the numbers are not limited thereto.

Note that phase control of beamforming may be performed with the sub-array antenna 211 as one unit.

In FIG. 5, the slits 351 are provided outside the dielectric cylinder 350, but may be provided inside the dielectric cylinder 350.

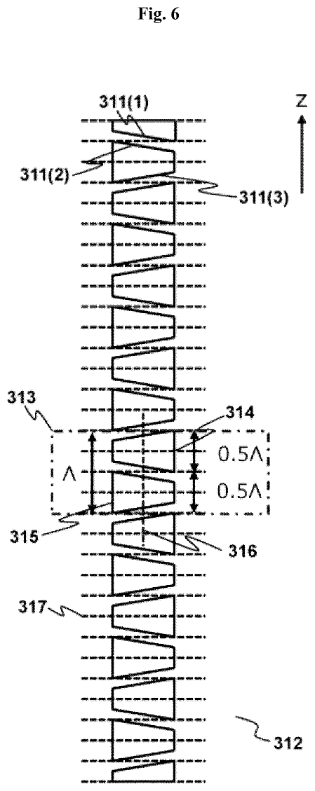

FIG. 6 is a configuration example of a slot array according to the first embodiment of the present disclosure. The slot array 312 includes a plurality of slots 311 arranged with a cycle A in a direction (z axis) parallel to the central axis of the cylinder formed by the rectangular waveguides 310. In FIG. 6, the unit structure 313 is the smallest unit structure corresponding to one period of the slot array 312.

The unit structure 313 has a structure in which slots 311 are disposed in the leg portions of the first isosceles trapezoid 314 and the second isosceles trapezoid 315. The length of the base of each of the first isosceles trapezoid 314 and the second isosceles trapezoid 315 is ½ cycle (0.5Λ). On a wall of rectangular waveguide 310 that is a side surface of a cylinder formed by the rectangular waveguides 310, the first isosceles trapezoid 314 has a symmetry axis that is a tangent line of the cylinder perpendicular to a central axis of the cylinder. Further, the second isosceles trapezoid 315 is a figure obtained by shifting the first isosceles trapezoid 314 by ½ cycle in a direction parallel to the central axis, and further symmetrically moving about an axis 316 (hereinafter, referred to as a half-value axis 316) in which a distance from an upper side and a lower side of the first isosceles trapezoid is equal as an axis of symmetry.

The cycle Λ of the slot array 312 is set to be equal to the wavelength at one frequency of the arriving radio wave. As a result, in the beamforming, the phase control can be performed so as to enhance the generation efficiency of the radio wave having a desired propagation characteristic.

A grid 317 has a structure in which thin linear metals arranged in the circumferential direction are periodically arranged in the z-axis direction on the side surface of the dielectric cylinder 350 described above. The above-described slit 351 is formed by the gap between the adjacent grids 317. FIG. 6 illustrates a state in which the grid 317 is orthogonally projected with respect to the cylindrical side surface formed by the rectangular waveguide 310.

As described above, in the array antenna 210 of the present disclosure, the slot array 312 has a periodic structure and realizes desired beamforming characteristics and polarization characteristics. The slit 351 on the side surface of the dielectric cylinder 350 can suppress cross polarization.

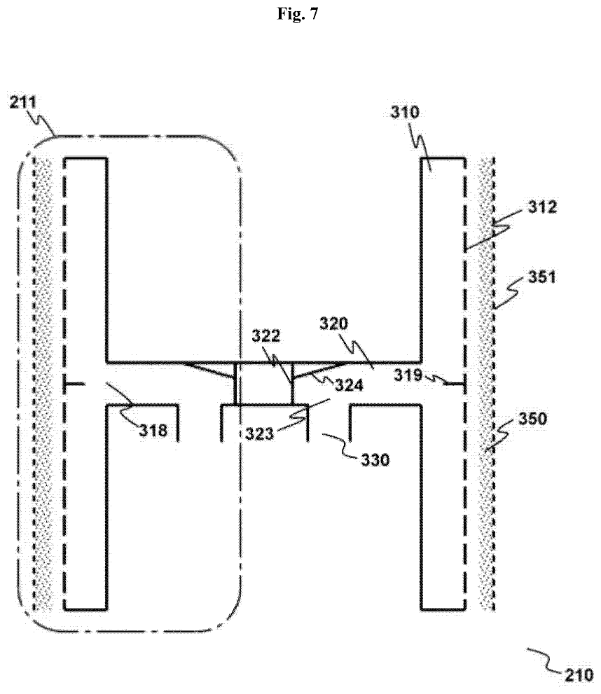

FIG. 7 is a two-dimensional cross-sectional view obtained by cutting the array antenna according to the first embodiment of the present disclosure in a diametrical direction. Here, a flow until the radio wave arriving at the array antenna 210 passes through the feed opening 330 will be described. First, the arrived radio wave passes through the dielectric cylinder 350 including the slits 351 and reaches the slot array 312. Further, the slot array 312 guides radio waves into the rectangular waveguide 310.

The radio wave having passed through the rectangular waveguide 310 is transmitted to the radial waveguide 320 through a T-branch 318. In the T-branch, the rectangular waveguide 310 includes a reflection suppressing wall 319 inside a wall facing a wall connected to the radial waveguide 320. The reflection suppressing wall 319 is a wall for preventing the radio wave from repeating total reflection at both ends in the tube axis direction of the rectangular waveguide 310 and from reciprocating in the tube. As a result, the influence of reflection on the reception power signal can be reduced.

The radio wave having passed through the radial waveguide 320 is transmitted from a vent 123 to the feed opening 330. A reflection suppressing wall 324 such as a taper is provided at a corner formed by the radial waveguide 320 and the wall 322 and opposite to the feed opening 330. As a result, it is possible to prevent radio waves from reciprocating in the radial waveguide 320.

As described above, in the array antenna 210, the arrived radio wave is guided into the device by the slot array 312 and transmitted to the feed opening 330 via the rectangular waveguide 310 and the radial waveguide 320. A plurality of antireflection structures are provided therein, and the influence of reflection on the reception power signal is reduced.

### Modification

Furthermore, in the radial waveguide 320, by setting the height of the internal space through which the radio wave propagates to a range of 0.5 to 1 wavelengths of the radio wave, a polarized wave parallel to the bottom surface of the radial waveguide 320 can be transmitted.

Note that both the reflection suppressing wall 319 and the reflection suppressing wall 324 are preferably provided, but either one may be provided in a case where it is difficult to install the array antenna 210 due to design or the like.

As described above with reference to FIGS. 3 to 7, the wireless communication system 100 of the present disclosure includes the array antenna 210 suitable as an antenna capable of realizing a low transmission loss even in the terahertz wave band. This makes it possible to measure a long-range arrival state even in a radio wave in the terahertz wave band.

### Modification

Note that, in FIGS. 3 to 7, a case where radio waves arrive at the array antenna 210 and the slot array 312 guides the radio waves into the device has been mainly described. This describes the function of the antenna to receive radio waves. However, the effects described in the present disclosure can be obtained not only at the time of reception but also at the time of transmission, and it can be said that the array antenna 210 of the present disclosure has a suitable configuration for both transmission and reception.

Note that, as described above, the array antenna 210 of the present disclosure can reduce the transmission loss of the radio wave in the terahertz wave band, and exhibits a particularly excellent effect on the terahertz wave band. However, the array antenna 210 of the present disclosure can also be used for radio waves in other frequency bands.

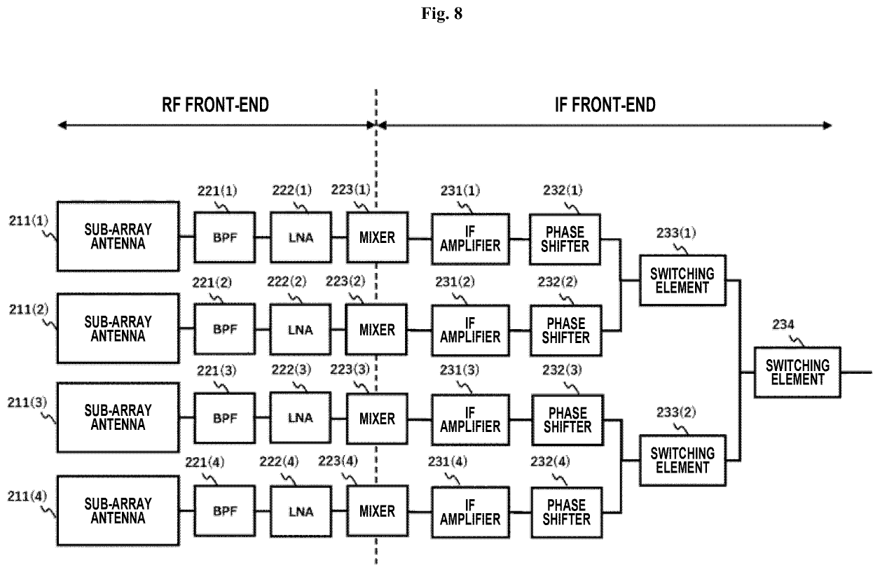

FIG. 8 is a diagram illustrating a configuration example of an RF-IF front-end part of the wireless communication system according to the first embodiment of the present disclosure. Here, a front-end configuration per sub-array group, which is a basic unit of signal processing, is illustrated. That is, in FIG. 8, (Nₐₙₜ/N_{g}) sub-array antennas 211 are present.

The RF front-end includes a sub-array antenna 211 and the above-described RF front-end circuit 220. The reception signal received by each sub-array antenna 211 is input from the feed opening 330 to the RF front-end circuit 220.

The RF front-end circuit 220 includes a band-pass filter (BPF) 221, a low noise amplifier (LNA) 222, and a mixer 223.

That is, in the reception signal input to the RF front-end circuit 220, only a high frequency in a desired band is extracted by the BPF 221 and amplified by the LNA 222. Further, the signal is down-converted into the intermediate frequency band by the mixer 223.

The IF front-end includes the IF front-end circuit 230 described above. The IF front-end circuit 230 includes an IF amplifier 231, a phase shifter 232, a switching element 233, and a switching element 234.

The signal in the intermediate frequency band input from the RF front-end is amplified to a predetermined signal level by the IF amplifier 231. The signal of each sub-array antenna 211 amplified by the IF amplifier 231 is output to the switching element 233 without being subjected to phase control by the phase shifter 232 except at the time of measuring the calibration data. The switching element 233 and the switching element 234 are used for switch control for outputting a signal to the baseband unit 140 for each sub-array group.

Note that the phase shifter 232 is used, for example, when measuring calibration data of the channel estimation value. By using the phase shifter 232, the phase of the signal in the intermediate frequency band can be aligned with respect to all the sub-array antennas 211, and the channel estimation value at the known arrival angle can be measured with high angular resolution.

As described above, in the wireless communication system 100 of the present disclosure, the RF-IF front-end part 130 performs switch control for each sub-array group and inputs a signal in the intermediate frequency band to the baseband unit 140. Further, by using the phase shifter 232 in the intermediate frequency band, it is possible to measure the calibration data of the channel estimation value with high phase resolution. By using calibration data having a high phase resolution, it is possible to prevent deterioration of angular resolution in the above-described beamforming processing.

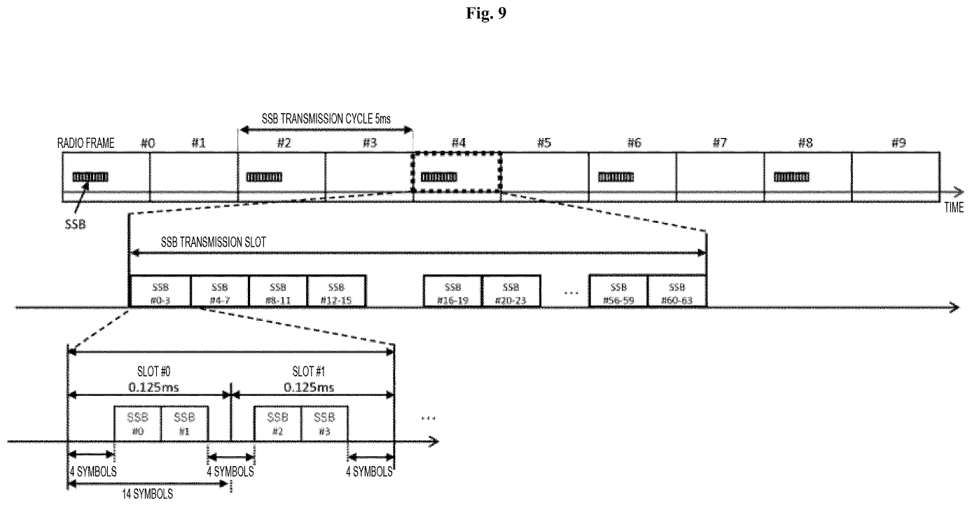

FIG. 9 is a diagram illustrating a configuration example of a signal format used in the wireless communication system according to the first embodiment of the present disclosure. The wireless communication system 100 performs arrival state analysis by using an SSB (Synchronization Signal/Physical Broadcast Channel Block) signal. The SSB signal includes a synchronization signal and a broadcast channel for signaling channel information necessary for the receiver to connect to the transmitter. FIG. 9 illustrates an example of an SSB signal in 5G New Radio. In addition, as an example, it is assumed here that the number of SSB transmissions is 64, the transmission cycle is 5 ms, the subcarrier interval is 120 kHz, and one slot includes 14 symbols. When the subcarrier interval is 120 kHz and the channel width is 400 MHz, the number of subcarriers N_{sc} is 3300.

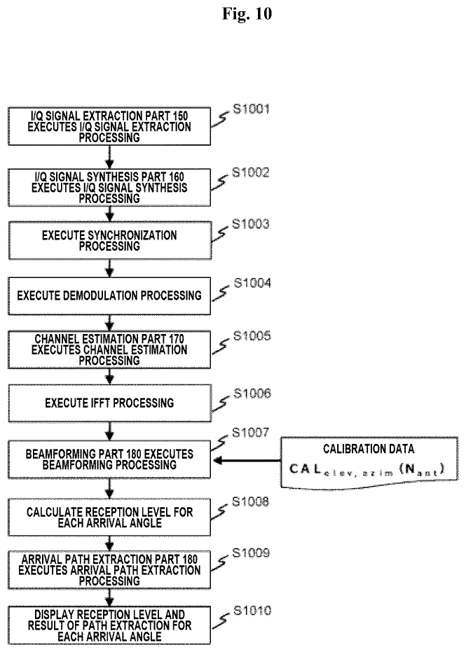

FIG. 10 is a flowchart of processing performed by the baseband unit in the wireless communication system according to the first embodiment of the present disclosure. First, the I/Q signal extraction part 150 executes I/Q signal extraction processing (step S1001). Here, in step S1001, oversampling may be performed at a frequency twice the frequency of the original signal to directly sample the in-phase component and the quadrature-phase component. Alternatively, the in-phase component and the quadrature-phase component may be extracted using a quadrature demodulator.

Next, the I/Q signal synthesis part 160 executes I/Q signal synthesis processing (step S1002). Further, a correlation calculation is performed on a result of the I/Q signal synthesis processing and processing (hereinafter, referred to as synchronization processing) of detecting a transmission timing of the SSB signal at which a correlation value is maximized is executed (step S1003). Further, on the basis of the transmission timing of the SSB signal detected by the synchronization processing, processing (hereinafter, referred to as demodulation processing) of performing fast Fourier transform (FFT) is performed on the result of the I/Q signal synthesis processing, and processing of OFDM demodulating the SSB signal is executed (step S1004).

Further, the channel estimation part 170 executes the channel estimation processing described above on the basis of the result of the demodulation processing (step S1005). Here, a channel estimation value R(N_{sc}, Nₐₙₜ) that is a matrix of the number of subcarriers N_{sc}×the number of subarray antennas Nₐₙₜ is obtained.

$$\begin{matrix}[ Math . 1 ] & \\ R ( \begin{matrix}a ( 0 , 0 ) & ⋯ & a ( 0 , {N}_{ant} ) \\ ⋮ & ⋱ & ⋮ \\ a ( {N}_{sc} , 0 ) & ⋯ & a ( {N}_{sc} , {N}_{ant} )\end{matrix} ) & ( Formula 1 )\end{matrix}$$

Further, processing (hereinafter, referred to as IFFT processing) of applying inverse FFT (IFFT) to the channel estimation value R(N_{sc}, Nₐₙₜ) is performed. As a result, the delay profile T(t, Nₐₙₜ) for each sub-array antenna can be calculated (step S1006).

$$\begin{matrix}[ Math . 2 ] & \\ T ( \begin{matrix}A ( 0 , 0 ) & ⋯ & A ( 0 , {N}_{ant} ) \\ ⋮ & ⋱ & ⋮ \\ A ( t , 0 ) & ⋯ & A ( t , {N}_{ant} )\end{matrix} ) & ( Formula 2 )\end{matrix}$$

Furthermore, the beamforming part 180 executes the above-described beamforming processing on the basis of the result of the IFFT processing (step S1007). Here, correlation calculation is performed from the calibration data CAL_{elev,azim} (Nₐₙₜ) for each arrival angle measured in advance and the delay profile T(t, Nₐₙₜ) calculated in step S1006, and the delay profile results BF_{elev,azim} for each arrival angle are calculated. This makes it possible to know the delay-angle profile for each arrival angle.

$$\begin{matrix}[ Math . 3 ] & \\ {BF}_{elev , axim} ( bf ( 0 ) = T ( \begin{matrix}A ( 0 , 0 ) & ⋯ & A ( 0 , {N}_{ant} ) \\ ⋮ & ⋱ & ⋮ \\ A ( t , 0 ) & ⋯ & A ( t , {N}_{ant} )\end{matrix} ) \times {CAL}_{elev , azim} ( \begin{matrix}c ( 0 ) \\ ⋮ \\ c ( {N}_{ant} )\end{matrix} ) & ( Formula 3 )\end{matrix}$$

Here, the calibration data CAL_{elev,azim} (Nₐₙₜ) can be obtained by calculating the complex conjugate with respect to the channel estimation value R(N_{sc}, Nₐₙₜ) at the known arrival angle measured in the anechoic chamber in advance. However, in the measurement of the channel estimation value R(N_{sc}, Nₐₙₜ) at a known arrival angle, the phase shifter 232 is controlled for each sub-array antenna 211 to align the phases of the signals in the intermediate frequency band, and the frequency characteristics in the channel band are assumed to be the same.

$$\begin{matrix}[ Math . 4 ] & \\ {CAL}_{elev , azin} ( c ( {N}_{ant} ) ) = conj ( \frac{1}{{N}_{sc}} {\sum }_{k = 0}^{{N}_{sc} - 1} {R}_{elev , azim} ( a ( k , {N}_{ant} ) ) ) & ( Formula 4 )\end{matrix}$$

Furthermore, a delay path is extracted on the basis of the delay profile results BF_{elev,azim} for each arrival angle calculated in step S1007, and the delay paths are added to calculate a reception level for each arrival angle (step S1008). The reception level for each arrival angle is also referred to as an angle profile. Next, based on the reception level for each arrival angle calculated in step S1008, the arrival path extraction part 190 executes the above-described arrival path extraction processing (step S1009). Finally, the reception level and the result of path extraction for each arrival angle are displayed (step S1010).

As described above with reference to the flowchart, the baseband unit 140 of the wireless communication system 100 of the present disclosure can extract the reception level and the arrival path for each arrival angle. According to the present disclosure, it is possible to provide the wireless communication system 100 particularly suitable as a channel sounder that estimates a reception level and an arrival path for each arrival angle as an arrival state of a radio wave.

As described above, according to the present disclosure, it is possible to provide a wireless communication system, a wireless communication device, a wireless communication method, and a wireless communication program capable of measuring a long-range arrival state with high angular resolution even in a radio wave in the terahertz wave band and realizing real-time signal processing.

### Modification

Note that, as described above, the wireless communication system 100 of the present disclosure exhibits a particularly excellent effect on the radio wave in the terahertz wave band, but the frequency band of the radio wave that can be measured by the wireless communication system 100 of the present disclosure is not limited to the terahertz band.

### REFERENCE SIGNS LIST

100 Wireless communication system
110 Antenna unit
120 Array antenna part
130 RF-IF front-end part
140 Baseband unit
150 I/Q signal extraction part
160 I/Q signal synthesis part
170 Channel estimation part
180 Beamforming part
190 Arrival path extraction part
210 Array antenna
211 Sub-array antenna
220 RF front-end circuit
221 BPF
222 LNA
223 Mixer
230 IF front-end circuit
231 IF amplifier
232 Phase shifter
233 Switching element
234 Switching element
241 Analog-to-digital converter
242 First processing circuit
243 DSP
244 Storage
245 Second processing circuit
246 DSP
247 DSP controller
310 Rectangular waveguide
311 Slot
312 Slot array
313 Unit structure
314 First isosceles trapezoid
315 Second isosceles trapezoid
316 Half-value axis
317 Grid
318 T-branch
319 Reflection suppressing wall
320 Radial waveguide
321 Wall
322 Wall
323 Vent
324 Reflection suppressing wall
330 Feed opening
350 Dielectric cylinder
351 Slit

1. A wireless communication system that estimates an arrival state of an arriving radio wave for each of arrival angles, the wireless communication system comprising:
an array antenna that receives the radio wave;
an RF-IF front-end circuitry that converts a high-frequency reception signal generated by the array antenna into a signal in an intermediate frequency band for each of reception sections of the array antenna; and
a baseband circuitry that estimates the arrival state on a basis of the signal in the intermediate frequency band, wherein
the array antenna includes
a plurality of rectangular waveguides in which tube axes are parallel to each other and which are arranged in a cylindrical shape such that short sides are located on a circle in a rectangular cross section perpendicular to the tube axis, and
a cylindrical radial waveguide disposed inside a cylinder formed by the plurality of rectangular waveguides and T-shaped connected to the plurality of rectangular waveguides,
the radial waveguide includes
a plurality of feed openings arranged to have rotational symmetry about a central axis of the cylinder,
each of the rectangular waveguide includes
a slot array in an arrangement direction parallel to the center axis of the cylinder on a wall that is a side surface of the cylinder,
the radial waveguide and the rectangular waveguide are configured to be hollow waveguides, and
the baseband circuitry includes
a plurality of digital signal processors that perform parallel processing on the digitized signal in the intermediate frequency band.

2. The wireless communication system according to claim 1, wherein
the baseband circuitry is configured to execute:
digitizing the signal in the intermediate frequency band for each of the reception sections to extract an in-phase component and a quadrature-phase component;
collecting and synthesizing digital signals including the in-phase component and the quadrature-phase component extracted for all the reception sections;
performing a correlation calculation on a result of the signal synthesis and detecting a transmission timing of the reception signal at which a correlation value is maximized;
performing OFDM demodulation on a result of the signal synthesis on a basis of the transmission timing;
calculating, for each subcarrier and each of the reception sections, a channel estimation value that is an estimation result of an amplitude and a phase when the radio wave passes through a propagation path on a basis of a result of the demodulation;
beamforming for calculating a delay profile of the radio wave for each of the arrival angles on a basis of a result obtained by performing IFFT on the channel estimation value;
calculating a reception level for each of the arrival angles of the radio wave on a basis of the delay profile; and
extracting an arrival path for each of the arrival angles of the radio wave on a basis of the reception level for each of the arrival angles.

3. The wireless communication system according to claim 1, wherein a frequency band of the radio wave is a terahertz wave band.

4. The wireless communication system according to claim 2, wherein
the RF-IF front-end circuitry further includes a phase shifter that performs phase control on each of the signals in the intermediate frequency band converted for each of the reception sections, and
the baseband circuitry calculates the delay profile of the radio wave for each of the arrival angles using calibration data of the channel estimation value measured using the phase shifter in the beamforming.

5. The wireless communication system according to claim 2, wherein the signal synthesis is executed by the plurality of digital signal processors.

6. A wireless communication device that estimates an arrival state of a radio wave received by another wireless device for each of arrival angles, the wireless communication device being configured to execute:
receiving a signal in an intermediate frequency band based on a reception signal of a radio wave received by the other wireless device for each of reception sections of the other wireless device;
digitizing the signal in the intermediate frequency band for each of the reception sections to extract an in-phase component and a quadrature-phase component;
collecting and synthesizing digital signals including the in-phase component and the quadrature-phase component extracted for all the reception sections;
performing a correlation calculation on a result of the signal synthesis and detecting a transmission timing of the reception signal at which a correlation value is maximized;
performing OFDM demodulation on a result of the signal synthesis on a basis of the transmission timing;
calculating, for each subcarrier and each of the reception sections, a channel estimation value that is an estimation result of an amplitude and a phase when the radio wave passes through a propagation path on a basis of a result of the demodulation;
beamforming for calculating a delay profile of the radio wave for each of the arrival angles on a basis of a result obtained by performing IFFT on the channel estimation value;
calculating a reception level for each of the arrival angles of the radio wave on a basis of the delay profile; and
extracting an arrival path for each of the arrival angles of the radio wave on a basis of the reception level for each of the arrival angles, and the wireless communication device comprising
a plurality of digital signal processors that execute the signal synthesis in parallel.

7. A wireless communication method for estimating an arrival state of an arriving radio wave for each of arrival angles, the wireless communication method comprising:
receiving the radio wave by an array antenna;
converting a high-frequency reception signal generated by the array antenna into a signal in an intermediate frequency band for each of reception sections of the array antenna by an RF-IF front-end circuitry;
digitizing, by a baseband circuitry, the signal in the intermediate frequency band for each of the reception sections to extract an in-phase component and a quadrature-phase component;
collecting and synthesizing, by a baseband circuitry, digital signals including the in-phase component and the quadrature-phase component for all of the reception sections;
performing, by a baseband circuitry, a correlation calculation on a result of the synthesizing and detecting a transmission timing of the reception signal at which a correlation value is maximized;
performing, by a baseband circuitry, OFDM demodulation on a result of the synthesizing on a basis of the transmission timing;
calculating, by a baseband circuitry, for each subcarrier and each of the reception sections, a channel estimation value that is an estimation result of an amplitude and a phase when the radio wave passes through a propagation path on a basis of a result of the OFDM demodulation;
calculating, by a baseband circuitry, a delay profile of the radio wave for each of the arrival angles on a basis of a result obtained by performing IFFT on the channel estimation value;
calculating, by a baseband circuitry, a reception level for each of the arrival angles of the radio wave on a basis of the delay profile; and
extracting, by a baseband circuitry, an arrival path for each of the arrival angles of the radio wave on a basis of the reception level for each of the arrival angles.

8. A storage medium storing a computer readable wireless communication program executed by the wireless communication device according to claim 6, that estimates an arrival state of a radio wave received by another wireless device for each of arrival angles, the wireless communication program including a program for causing one or more processer included in the wireless communication device to execute:
collecting and synthesizing digital signals including an in-phase component and a quadrature-phase component extracted from a signal in an intermediate frequency band based on a reception signal of a radio wave received by the other wireless device for all the reception sections of the other wireless device;
performing a correlation calculation on a result of the signal synthesis processing and detecting a transmission timing of the reception signal at which a correlation value is maximized;
performing OFDM demodulation on a result of the signal synthesis on a basis of the transmission timing;
calculating, for each subcarrier and each of the reception sections, a channel estimation value that is an estimation result of an amplitude and a phase when the radio wave passes through a propagation path on a basis of a result of the demodulation;
beamforming for calculating a delay profile of the radio wave for each of the arrival angles on a basis of a result obtained by performing IFFT on the channel estimation value;
calculating a reception level for each of the arrival angles of the radio wave on a basis of the delay profile; and
extracting an arrival path for each of the arrival angles of the radio wave on a basis of the reception level for each of the arrival angles.

9. The wireless communication system according to claim 2, wherein a frequency band of the radio wave is a terahertz wave band.
